(19) United States
(12) Patent Application Publication
(10) Pub. No.: US 2024/0012296 A1
(43) Pub. Date: Jan. 11, 2024

(54) PANEL DEVICE

(71) Applicant: InnoLux Corporation, Miao-Li County (TW)

(72) Inventors: Hong-Sheng HSIEH, Miao-Li County (TW); Chih-Yung HSIEH, Miao-Li County (TW); Yi-Hsin CHEN, Miao-Li County (TW)

(21) Appl. No.: 18/331,456

(22) Filed: Jun. 8, 2023

(30) Foreign Application Priority Data
Jul. 8, 2022 (CN) 202210807006.4

(51) Int. Cl. G02F 1/1343

(52) U.S. Cl. CPC G02F 1/134318; G02F 1/13439

(57) ABSTRACT

A panel device includes a first substrate, a second substrate, a liquid crystal layer, a first conductive layer and a second conductive layer. The second substrate is arranged to be opposite to the first substrate. The liquid crystal layer is arranged between the first substrate and the second substrate. The first conductive layer is arranged on the first substrate and includes a patterned electrode. The patterned electrode has a plurality of main electrodes and auxiliary electrodes arranged in parallel. The second conductive layer is arranged on the second substrate. The main electrodes and the auxiliary electrodes are arranged alternately in one direction.

### CROSS-REFERENCE TO RELATED APPLICATIONS

This application claims the benefits of the Chinese Patent Application Serial Number 202210807006.4, filed on Jul. 8, 2022, the subject matter of which is incorporated herein by reference.

### BACKGROUND

### Field of the Disclosure

The present disclosure relates to a panel device and, more particularly, to a liquid crystal lens panel device.

### Description of Related Art

Currently, the imaging effect on the panel is provided through designing slender conductive electrodes on the lower substrate, and applying external electric signal to generate electric field so that the refractive index on the panel changes with the position for being equivalent to the lens characteristic.

However, due to the aforementioned conductive electrode being extremely slender, it is likely to cause disconnection and defects and thus lead to the failure of conduction, resulting in that part of the lens characteristic fails.

To solve this problem, in the prior art, laser is used to weld and repair the disconnection of the conductive electrode. However, the welding takes a long time and cannot meet the actual demand.

Therefore, it is desired to provide an improved panel device to solve the aforementioned problems.

### SUMMARY

The present disclosure provides a panel device, which can effectively reduce the risk of disconnection through stacking design and process change.

To achieve the object, the panel device of the present disclosure includes: a first substrate; a second substrate arranged opposite to the first substrate; a liquid crystal layer arranged between the first substrate and the second substrate; a first conductive layer arranged on the first substrate, and provided with a patterned electrode having a plurality of main electrodes and auxiliary electrodes arranged in parallel; and a second conductive layer arranged on the second substrate, wherein the main electrodes and the auxiliary electrodes are arranged alternately in one direction.

Other novel features of the disclosure will become more apparent from the following detailed description when taken in conjunction with the accompanying drawings.

### BRIEF DESCRIPTION OF DRAWINGS

FIG. 1 is a schematic diagram of the panel device according to an embodiment of the present disclosure;

FIG. 2A is a schematic diagram of the patterned electrode of the first conductive layer according to an embodiment of the present disclosure;

FIG. 2B is a schematic diagram of part of the first conductive layer according to an embodiment of the present disclosure;

FIG. 3A is a schematic diagram of the main electrode and auxiliary electrode manufactured by using two processes according to an embodiment of the present disclosure;

FIG. 3B is a schematic diagram of the main electrode and auxiliary electrode manufactured by using two processes according to an embodiment of the present disclosure, in which defects occur;

FIG. 4A is a schematic diagram illustrating the main electrode and the auxiliary electrode at cross-section line L-L′ manufactured by using two processes;

FIG. 4B is another schematic diagram illustrating the main electrode and the auxiliary electrode at cross-section line L-L′ manufactured by using two processes;

FIG. 4C is still another schematic diagram illustrating the main electrode and the auxiliary electrode at cross-section line L-L′ manufactured by using two processes;

FIG. 5 is a schematic diagram of the main electrode and auxiliary electrode manufactured by using two processes according to another embodiment of the present disclosure; and

FIG. 6 is a schematic diagram of the main electrode and auxiliary electrode manufactured by using a high-impedance film to cover the first conductive layer according to still another embodiment of the present disclosure.

### DETAILED DESCRIPTION OF EMBODIMENT

Different embodiments of the present disclosure are provided in the following description. These embodiments are meant to explain the technical content of the present disclosure, but not meant to limit the scope of the present disclosure. A feature described in an embodiment may be applied to other embodiments by suitable modification, substitution, combination, or separation.

It should be noted that, in the present specification, when a component is described to “comprise”, “have”, “include” an element, it means that the component may include one or more of the elements, and the component may include other elements at the same time, and it does not mean that the component has only one of the element, except otherwise specified.

Moreover, in the present specification, the ordinal numbers, such as “first” or “second”, are only used to distinguish a plurality of elements having the same name, and it does not means that there is essentially a level, a rank, an executing order, or an manufacturing order among the elements, except otherwise specified. The ordinal numbers of the elements in the specification may not be the same in claims. For example, a “second” element in the specification may be a “first” element in the claims.

In the present specification, except otherwise specified, the feature A “or” or “and/or” the feature B means only the existence of the feature A, only the existence of the feature B, or the existence of both the features A and B. The feature A “and” the feature B means the existence of both the features A and B.

Moreover, in the present specification, the terms, such as “top”, “upper”, “bottom”, “front”, “back”, or “middle”, as well as the terms, such as “on”, “above”, “over”, “under”, “below”, or “between”, are used to describe the relative positions among a plurality of elements, and the described relative positions may be interpreted to include their translation, rotation, or reflection.

Furthermore, the terms recited in the specification and the claims such as “above”, “over”, “on”, “below”, or “under” are intended that an element may not only directly contacts other element, but also indirectly contact the other element.

Furthermore, the term recited in the specification and the claims such as “connect” is intended that an element may not only directly connect to other element, but also indirectly connect to other element. On the other hand, the terms recited in the specification and the claims such as “electrically connect” and “couple” are intended that an element may not only directly electrically connect to other element, but also indirectly electrically connect to other element.

In the present specification, except otherwise specified, the terms (including technical and scientific terms) used herein have the meanings generally known by a person skilled in the art. It should be noted that, except otherwise specified in the embodiments of the present disclosure, these terms (for example, the terms defined in the generally used dictionary) should have the meanings identical to those skilled in the art, the background of the present disclosure or the context of the present specification, and should not be read by an ideal or over-formal way.

FIG. 1 is a schematic diagram of the panel device according to an embodiment of the present disclosure. The panel device 10 includes a first substrate 11, a first conductive layer 12, a liquid crystal layer 13, a second conductive layer 14 and a second substrate 15. The second substrate 15 is arranged to be opposite to the first substrate 11. The liquid crystal layer 13 is arranged between the first substrate 11 and the second substrate 15. The second conductive layer 14 is arranged on the second substrate 15. The first conductive layer 12 is arranged on the first substrate 11, and the first conductive layer 12 includes a patterned electrode 20. When an electric signal is applied to the first conductive layer 12 and the second conductive layer 14, an electric field is generated in the liquid crystal layer 13 to cause the liquid crystals in the liquid crystal layer 13 to rotate, so that the refractive index in the space changes with the position, which may be equivalent to the lens characteristic. In the aforementioned embodiment, the patterned electrode 20 is arranged on the first conductive layer 12, but the present disclosure is not limited thereto. In other embodiments, the patterned electrode 20 is arranged on the second conductive layer 14, which may also achieve the same effect.

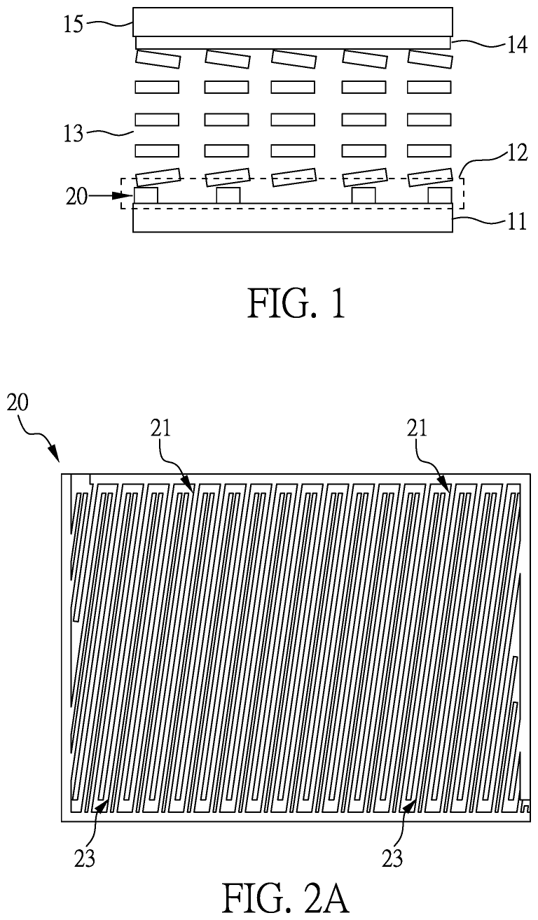

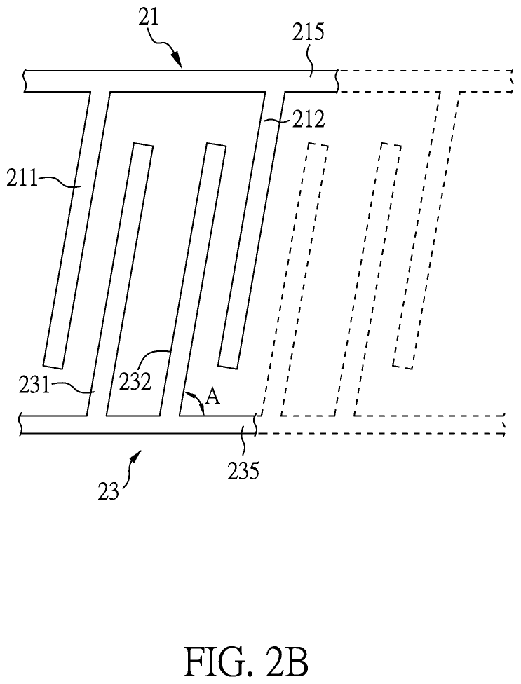

FIG. 2A is a schematic diagram of the patterned electrode 20 of the first conductive layer 12 according to an embodiment of the present disclosure, wherein the patterned electrode 20 may be fabricated by exposure and development in an array manner, but the present disclosure is not limited thereto. As shown, the patterned electrode 20 has a plurality of main electrodes 21 and a plurality of auxiliary electrodes 23 arranged in parallel, and please also refer to FIG. 2B which is a schematic diagram of part of the first conductive layer 12 according to an embodiment of the present disclosure, wherein, in FIG. 2B, only one of the main electrodes 21 and one of the auxiliary electrode 23 of the first conductive layer 12 are shown in FIG. 2B for convenience of description, without meaning that the patterned electrode 20 has only one main electrode 21 and one auxiliary electrode 23, and the following descriptions of the present disclosure are given based on this.

As shown in FIG. 2A and FIG. 2B, the auxiliary electrode 23 includes at least two sub-electrodes 231, 232 arranged in parallel, and the sub-electrodes 231, 232 of the auxiliary electrode 23 are electrically connected together by an auxiliary electrode connection line 235 at their respective ends, while the sub-electrodes 231 and 232 of the plurality of auxiliary electrodes 23 are electrically connected together by the auxiliary electrode connection line 235 at their respective ends. The main electrode 21 may also include at least two sub-electrodes 211, 212 arranged in parallel, and the sub-electrodes 211, 212 of the main electrode 21 are electrically connected together by a main electrode connection line 215 at their respective ends, while the sub-electrodes 211, 212 of the plurality of main electrodes 21 are electrically connected together by the main electrode connection line 215 at their respective ends. The main electrode connection line 215 and the auxiliary electrode connection line 235 may be respectively arranged, for example, along two opposite sides of the first conductive layer 12, but the present disclosure is not limited thereto. In addition, for adjacent main electrodes and auxiliary electrodes, as shown by the dotted line in FIG. 2B, two adjacent main electrodes share one sub-electrode 212.

With reference to FIG. 2A and FIG. 2B again, the two sub-electrodes 231, 232 of the auxiliary electrode 23 are arranged between the two sub-electrodes 211, 212 of the main electrode 21, and there is an inclination angle A between one sub-electrode 231, 232 of the auxiliary electrode 23 and the auxiliary electrode connecting line 235, where the inclination angle A may be in a range of 45 degrees to 90 degrees. Therefore, the plurality of main electrodes 21 and the plurality of auxiliary electrodes 23 are alternately arranged in one direction according to the inclination angle A. For example, when the inclination angle A is 90 degrees, the plurality of main electrodes 21 and the plurality of auxiliary electrodes 23 are alternately arranged in the horizontal direction in FIG. 2A.

In the process of manufacturing the main electrodes 21 and the auxiliary electrodes 23, in order to avoid disconnection, the present disclosure is provided to manufacture the main electrodes 21 and the auxiliary electrodes 23 by using two processes, or to manufacture the main electrodes 21 and the auxiliary electrodes 23 by using one process and a high-impedance film covering, as described below.

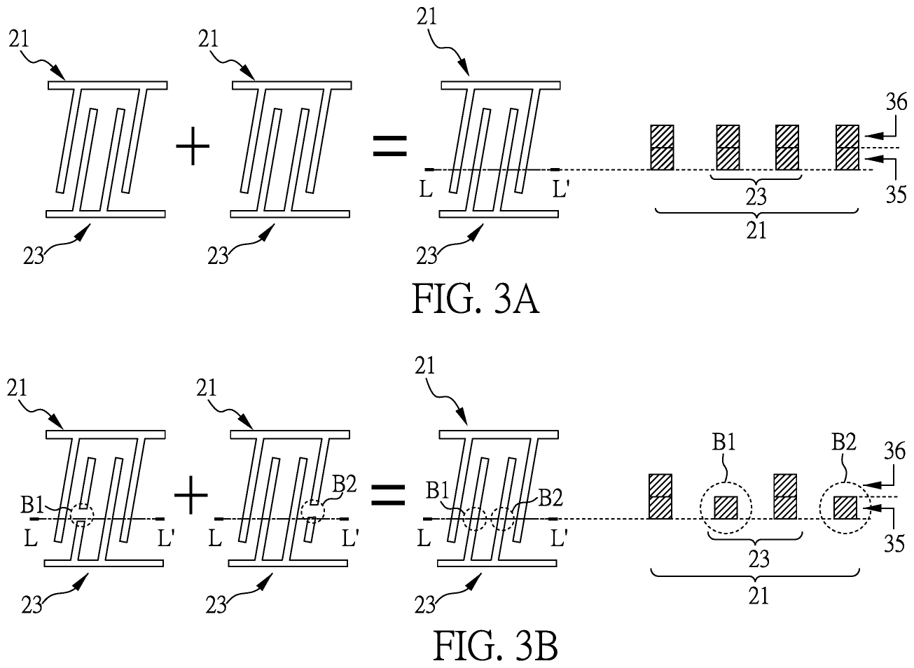

FIG. 3A is a schematic diagram of the main electrode 21 and auxiliary electrode 23 manufactured by using two processes according to an embodiment of the present disclosure, wherein the first process and the second process may use the same photo-mask or developing method, so that the first process may form a layer of main electrodes 21 and auxiliary electrodes 23, and the second process may form a layer of main electrodes 21 and auxiliary electrodes 23 again. Therefore, the main electrode 21 and auxiliary electrode manufactured by these two processes 23 each have two layers of electrodes. That is, as shown in FIG. 3A, at the cross-section line LL′ of the main electrode 21 and the auxiliary electrode 23, the main electrode 21 has a first layer 35 and a second layer 36, and the second layer 36 of the main electrode 21 is directly arranged on the first layer 35 thereof. Similarly, the auxiliary electrode 23 has a first layer 35 and a second layer 36, and the second layer 36 of the auxiliary electrode 23 is directly arranged on the first layer 35 thereof. Since the first layer 35 and the second layer 36 are manufactured by two processes respectively, the thickness of the first layer 35 and the thickness of the second layer 36 may be different.

Based on the random distribution of defects in the manufacturing process, when the main electrodes 21 and the auxiliary electrodes 23 are formed by repeatedly manufacturing two layers of electrodes, the probability of defects occurring at the same position of the main electrode 21 or the auxiliary electrode 23 is extremely low, and thus the occurrence of disconnection may be effectively avoided. For example, as shown in FIG. 3B, which is a schematic diagram of the main electrode 21 and auxiliary electrode 23 manufactured by using two processes, in which there are defects occurring. As shown, it is assumed that the auxiliary electrode 23 manufactured in the first process has a disconnection B1 on the cross-section line LU, and the main electrode 21 manufactured in the second process has a disconnection B2 on the cross-section line LU, as shown, at the cross-section line LU of the main electrode 21 and the auxiliary electrode 23 manufactured after completing the two processes, the disconnection B1 of the auxiliary electrode 23 occurring in the first process may be filled by the electrode manufactured in the second process, and thus there is no disconnection anymore. Furthermore, although the main electrode 21 has a disconnection B2 occurring in the second process, the main electrode 21 will not have any disconnection due to that an electrode manufactured in the first process had already been existed at the disconnection B2.

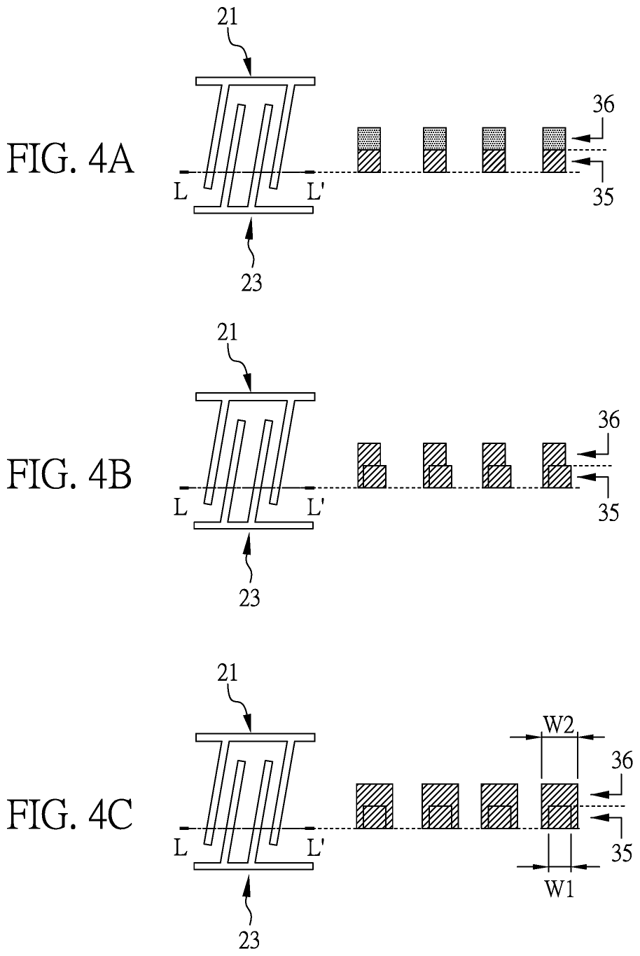

In addition, since the present disclosure uses two processes to manufacture the main electrode 21 and the auxiliary electrode 23, in order to identify the two layers of electrodes, the present disclosure may further utilize the difference between the two processes to make the two layers of electrodes identifiable. FIG. 4A is a schematic diagram illustrating the main electrode 21 and the auxiliary electrode 23 at cross-section line L-U, as those of FIG. 3A, according to the present disclosure. Please refer to FIG. 4A and FIG. 3A together, wherein the electrode materials used in the first process and second process are different, for example, are different conductive materials. Therefore, the interface between the first layer 35 and the second layer 36 may be identified through the difference in materials. FIG. 4B is another schematic diagram illustrating the main electrode 21 and the auxiliary electrode 23 at the cross-section line LL′, as those of FIG. 3A, according to the present disclosure. Please refer to FIG. 4B and FIG. 3A together, wherein there is a slight displacement between the exposures in the first process and the second process. Therefore, the two layers of electrodes are slightly misaligned, so that the first layer 35 and the second layer 36 are partially overlapped. In the same way, similarly to FIG. 4A, in this embodiment, the electrode material used in the first process may also be different from the electrode material used in the second process, so as to further enhance the degree of identification of the two layers of electrodes. FIG. 4C is still another schematic diagram illustrating the main electrode 21 and the auxiliary electrode 23 at the cross-section line LL′, as those of FIG. 3A, according to the present disclosure. Please refer to FIG. 4C and FIG. 3A together, wherein the exposure intensities used in the exposure operations of the first process and the second process are different so that the line widths of the two layers of electrodes are different. For example, when using a positive photoresist material, if strong exposure is used in the first process and weak exposure is used in the second process, the line width of the second layer 36 is greater than the line width of the first layer 35. That is, as shown in FIG. 4C, the top of the first layer 35 has a first width W1, and the top of the second layer 36 has a second width W2, where the second width W2 is greater than the first width W1. On the contrary, if weak exposure is used in the first process and strong exposure is used in the second process, the second width W2 is smaller than the first width W1. In the same way, similar to FIG. 4A, in this embodiment, the electrode material used in the first process may also be different from the electrode material used in the second process. The electrode material includes a metal oxide material, and an example of the metal oxide material may include indium tin oxide (ITO), aluminum zinc oxide (AZO), indium gallium zinc oxide (IGZO), antimony tin oxide (ATO), fluorine-doped tin oxide (FTO), or a combination thereof, but the present disclosure is not limited thereto. Accordingly, the degree of identification of the two layers of electrodes may be increased.

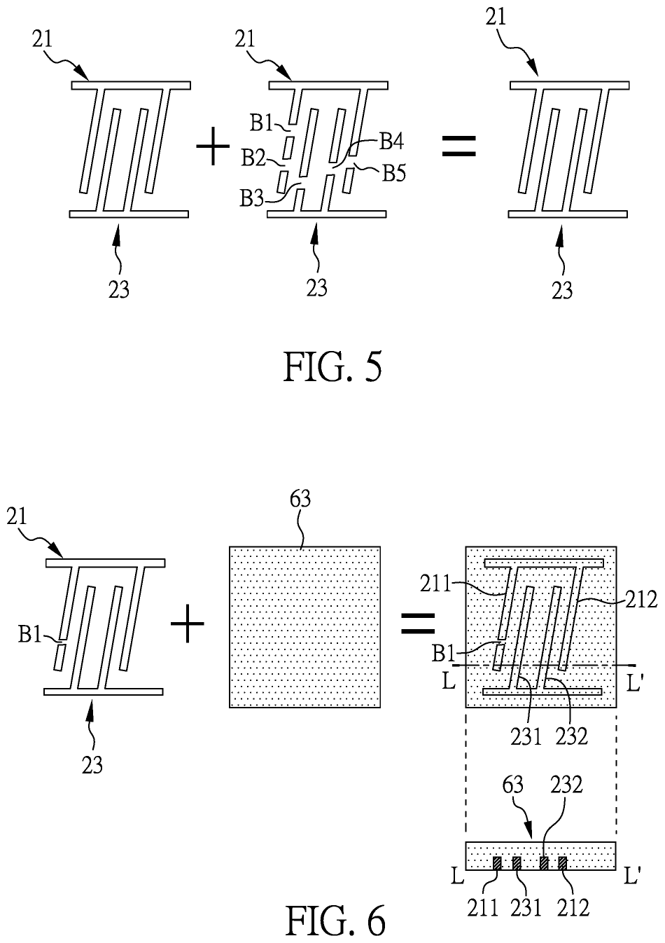

FIG. 5 is a schematic diagram of the main electrode 21 and auxiliary electrode 23 manufactured by using two processes according to another embodiment of the present disclosure. This embodiment is similar to the previous embodiment except that, for example, the first process and the second process may use different photo-masks or development methods, wherein the shape of the photo-mask of the first process and the shape of the photo-mask of the second process are similar but not identical, and there is at least one random disconnection at the position where the electrodes are formed in the second process so that the main electrode 21 and the auxiliary electrode 23 manufactured in the second process have at least one disconnection B1-B5. However, because the disconnection caused by the process defect is also random in space, and thus this embodiment may also achieve the effect of reducing the probability of disconnection.

FIG. 6 is a schematic diagram of the main electrode 21 and auxiliary electrode23 manufactured by using a high-impedance film to cover the patterned electrode according to still another embodiment of the present disclosure. In this embodiment, the material of the main electrode 21 and the auxiliary electrode 23 manufactured in the first conductive layer 12 has excellent conductivity, wherein the material with excellent conductivity is, for example, metal with an impedance smaller than 70 Ω. In addition, in another embodiment, the material of the main electrode 21 is metal, and the material of the auxiliary electrode 23 is non-metal (e.g., ITO), while the two materials are different. The process of covering the high-impedance film is provided to cover all of the main electrodes 21 and the auxiliary electrodes 23 with a high-impedance film 63, as shown in FIG. 6 that illustrates the cross-sectional view of the main electrode 21 and the auxiliary electrode 23 covered with the high-impedance film 63 at the cross-section line LL′. The high-impedance film 63 may be made of material with poor conductivity, such as indium tin oxide (ITO) or polyethylene glycol thiophene (PEDOT), which has an impedance greater than or equal to 1×10⁴ Ω/□ and smaller than or equal to 1×10⁹ Ω/□. The high-impedance film 63 is, for example, an indium tin oxide with a film thickness smaller than 50 Å, but the present disclosure is not limited thereto. Moreover, as shown in FIG. 6, it is assumed that there is a disconnection B1 on the sub-electrode 211 of the main electrode 21 manufactured by the photo-mask process, and the high-impedance film 63 covers the main electrode 21 and the auxiliary electrode 23. Based on the high impedance characteristic of the high-impedance film 63, for the main electrode 21 and the auxiliary electrode 23 that belong to different electrodes, the distance between the sub-electrodes 211, 212 of the main electrode 21 and the sub-electrodes 231, 232 of the auxiliary electrode 23 is far enough (for example, greater than 70 μm), and thus the non-conduction state between the main electrode 21 and the auxiliary electrode 23 may still be maintained. However, for the main electrode 21 or the auxiliary electrode 23 that belongs to the same electrode, since the disconnection caused by general defects is extremely small (for example, smaller than 10 μm), the sub-electrode 211 of the main electrode 21 may still be conducted through the high-impedance film 63 on the aforementioned disconnection B1, so as to avoid the problem of disconnection.

From the above description, it can be seen that the present disclosure uses two photo-mask processes to manufacture the main electrodes and the auxiliary electrodes, or uses one photo-mask process and a high-impedance film covering to manufacture the main electrodes and the auxiliary electrodes, so as to surely avoid disconnection thereby effectively ensuring the lens characteristics of the panel device.

As long as the features of the various embodiments disclosed in the present disclosure do not violate or conflict the spirit of the invention, they can be mixed and matched arbitrarily.

The aforementioned specific embodiments should be construed as merely illustrative, and not limiting the rest of the present disclosure in any way.

1. A panel device, comprising:
a first substrate;
a second substrate arranged opposite to the first substrate;
a liquid crystal layer arranged between the first substrate and the second substrate;
a first conductive layer arranged on the first substrate, and provided with a patterned electrode having a plurality of main electrodes and auxiliary electrodes arranged in parallel; and
a second conductive layer arranged on the second substrate,
wherein the main electrodes and the auxiliary electrodes are arranged alternately in one direction.

2. The panel device as claimed in claim 1, wherein one of the auxiliary electrodes includes at least two sub-electrodes arranged in parallel.

3. The panel device as claimed in claim 1, wherein one of the main electrodes has a first layer and a second layer, and the second layer is directly arranged on the first layer.

4. The panel device as claimed in claim 3, wherein a material of the first layer is different from that of the second layer.

5. The panel device as claimed in claim 3, wherein the first layer partially overlaps the second layer.

6. The panel device as claimed in claim 3, wherein a top of the first layer has a first width, and a top of the second layer has a second width, where the first width is different from the second width.

7. The panel device as claimed in claim 3, wherein a thickness of the first layer is different from that of the second layer.

8. The panel device as claimed in claim 1, further comprising a high-impedance film for covering the first conductive layer, wherein the high-impedance film has an impedance greater than or equal to 1×10⁴ Ω/□ and smaller than or equal to 1×10⁹ Ω/□.

9. The panel device as claimed in claim 8, wherein the main electrodes and the auxiliary electrodes have an impedance smaller than 70 Ω/□.

10. The panel device as claimed in claim 8, wherein a material of the main electrodes is different from that of the auxiliary electrodes.

11. The panel device as claimed in claim 10, wherein the material of the main electrodes is metal, and the material of the auxiliary electrodes is non-metal.

12. The panel device as claimed in claim 8, wherein a material of the main electrodes and the auxiliary electrodes is metal with an impedance smaller than 70 Ω.

13. The panel device as claimed in claim 8, wherein the high-impedance film is indium tin oxide with a film thickness smaller than 50 Å.

14. The panel device as claimed in claim 2, wherein the sub-electrodes of the auxiliary electrode are electrically connected together by an auxiliary electrode connection line at respective ends of the sub-electrodes, and there is an inclination angle between one sub-electrode of the auxiliary electrode and the auxiliary electrode connecting line.

15. The panel device as claimed in claim 14, wherein the inclination angle is between 45 degrees and 90 degrees.

16. The panel device as claimed in claim 2, wherein one of the main electrodes includes at least two sub-electrodes arranged in parallel, and the sub-electrodes of the main electrode 21 are electrically connected together by a main electrode connection line at respective ends of the sub-electrodes.

17. The panel device as claimed in claim 16, wherein the at least two sub-electrodes of the auxiliary electrode are arranged between the at least two sub-electrodes of the main electrode.

18. The panel device as claimed in claim 3, wherein a material of the first layer is different from that of the second layer, and the first layer partially overlaps the second layer.

19. The panel device as claimed in claim 3, wherein a material of the first layer is different from that of the second layer; a top of the first layer has a first width, a top of the second layer has a second width, and the first width is different from the second width.

20. The panel device as claimed in claim 4, wherein material of the first layer and material of the second layer are different conductive materials.
